(19) United States
(12) Patent Application Publication
(10) Pub. No.: US 2004/0131182 A1
(43) Pub. Date: Jul. 8, 2004

(54) Block cipher mode of operation for constructing a wide-blocksize block cipher from a conventional block cipher

(75) Inventor: Phillip W. Rogaway, Davis, CA (US)

Correspondence Address: JOHN P. O'BANION, O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA

(21) Appl. No.: 10/655,563

(22) Filed: Sep. 3, 2003

Related U.S. Application Data
(60) Provisional application No. 60/422,335, filed on Oct. 29, 2002.
(60) Provisional application No. 60/413,124, filed on Sep. 23, 2002.
(60) Provisional application No. 60/408,458, filed on Sep. 3, 2002.

(51) Int. Cl. H04K 1/06

(52) U.S. Cl. 380/37; 380/28

(57) ABSTRACT

A wide-blocksize block cipher that takes a possibly long string as plaintext and turns it into a ciphertext having the same length as the plaintext. Every bit of the ciphertext strongly depends on every bit of the plaintext. The wide-blocksize block cipher is made from a conventional block cipher, which is a block cipher that operates on strings of some small, fixed length. The wide-blocksize block cipher is obtained from the conventional block cipher by a three-step process. The first step is to encipher the plaintext using some mode of operation of the conventional block cipher. The second step is to mask the resulting intermediate value by way of a computationally cheap mixing step. The third step is to decipher the masked intermediate value using some mode of operation of the conventional block cipher. The specified steps may depend on a non-secret tweak, so that the wide-blocksize block cipher becomes tweakable. The method can be used for disk-sector encryption, to securely store user data on a mass-storage device.

### CROSS-REFERENCE TO RELATED APPLICATIONS

This application claims priority to U.S. provisional patent application serial No. 60/408,458, filed Sep. 3, 2002, incorporated herein by reference; to U.S. provisional patent application serial No. 60/413,124, filed Sep. 23, 2002, incorporated herein by reference; and to U.S. provisional patent application serial No. 60/422,335 filed on Oct. 29, 2002, incorporated herein by reference.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the public file or record of the United States Patent and Trademark Office, but otherwise reserves all copyright rights whatsoever. The copyright owner does not hereby waive any of its rights to have this patent document maintained in secrecy, including without limitation its rights pursuant to 37 C.F.R. § 1.14.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to cryptographic techniques for symmetric (shared-key) encryption schemes and, more particularly, to methods for using a conventional block cipher whose blocksize is n bits to construct a new block cipher that operates on more than n bits.

2. Description of Related Art.

When confidential information is stored on a mass-storage device, such as a disk, or sent across a communications network, such as the Internet, it is often “encrypted” using “symmetric” (also called “shared-key”) techniques. First, a “plaintext” P is transformed into a “ciphertext” C under the control of a “key” K. This process is called “encryption” (one is said to “encrypt” the plaintext P). Later, the ciphertext C can be transformed back into the plaintext P using the same key K. This second process is called “decryption” (one is said to “decrypt” the ciphertext C). The mechanism that one uses to encrypt and decrypt is called an “encryption scheme”.

### Block Ciphers

An important kind of encryption scheme is one where the encryption and decryption processes are deterministic and stateless (meaning that one gets the same ciphertext every time one encrypts a given plaintext with a given key) and where any ciphertext C has the same length as the plaintext P from which it comes. Such an encryption scheme is called a “block cipher”. Thus, a block cipher provides a means to turn a key K from a set of possible keys K and a plaintext P from a set of possible plaintexts X into a ciphertext C, again from X, where C has the same length as P. The block cipher must also provide a means to go “backwards”, turning the key K from K and the ciphertext C from X back into the plaintext P. A block cipher can thus be abstracted as a function E: K×X→X of a particular kind. Namely, the set K, called the “key space”, is a finite nonempty set; the set X, called the “message space”, is a nonempty set of binary strings; for any key K∈K and any plaintext P∈X, the ciphertext C=E(K, P) must have the same length as P; and for every key K∈K, the function E(K, •) is a permutation (meaning a one-to-one and onto function) on the message space X.

When E: K×X→X is a block cipher, E_{K}(P) is usually written instead of E(K, P). The inverse of E (the backwards direction of the block cipher) is written as D=E_{K}⁻¹. Thus D_{K}(C)=P if and only if C=E_{K}(P). The term “encipher” (instead of “encrypt”) is used when referring to applying a block cipher in its forward direction; to encipher is to compute from K and P the value E_{K}(P). The term “decipher” (instead of “decrypt”) is used when referring to applying a block cipher in its backward direction; to decipher is to compute from K and C a value E_{K}⁻¹(C).

If E is a block cipher then E⁻¹ is also block cipher, and it is therefore somewhat arbitrary which direction of E one regards as the “forward” direction and which direction one regards as the “backward” direction. Thus, when one refers to deciphering with a block cipher, one could just as well refer to enciphering but with respect to the block cipher that is the inverse block cipher. In other words, it is only a question of perspective whether one is enciphering or deciphering.

An important case where one must encipher (and not simply encrypt) is when encrypting the contents of a disk sector. A “disk sector” is the unit of storage on a mass-storage device. Typically, the 512-byte plaintext P at disk sector index T should be replaced by the 512-byte ciphertext C. The ciphertext C must be stored, in its entirety, exactly where P had been stored. This is why the length of C must be identical to the length of P.

In the above disk-sector-encryption problem, it is desirable that the ciphertext C depends not only on the plaintext P and the secret key K, but also on the “sector index” T. This way, what is known about the contents of a sector T will not be useful in understanding the contents of a different sector, T′. For example, if the two disk sectors P and P′ at distinct locations T and T′ happen to be identical, this will not be apparent from their ciphertext C and C′ even though they are obtained using the same key and the same plaintext. More generally, we call T the “tweak” and we consider block ciphers that support tweaks. Each tweak T causes the block cipher to behave in a different way when enciphering P. The tweak T is not secret. Formally, a “tweakable block-cipher” is a function E: K×T×X→X where K is a finite nonempty set (the “key space”) and T is a nonempty set (the “tweak space”) and X is a nonempty set of strings (the “message space”) and each E_{K}^{T}(•)=E(K,T,•) is a permutation on X. The “inverse” of the tweakable block-cipher E: K×T×X→X is the block cipher D=E⁻¹ having signature D: K×T×X→X and defined by D_{K}^{T}(C)=P if and only if E_{K}^{T}(P)=C.

From now on a block cipher E: K×X→X (that is, one that does not support a tweak) is called an “untweakable” block cipher and the term “block cipher” is used to mean either a tweakable block cipher E: K×T×X→X or an untweakable block cipher E: K×X→X. It makes sense to consider an untweakable block cipher as a kind of tweakable block cipher because one can always regard an untweakable block cipher E: K×X→X as a tweakable block cipher E*: K×T×X→X defined by setting T={ε} (meaning that T has only a single string, denoted ε) and letting E*(K,ε,X)=E(K,X).

A block cipher has been defined such that the message space X might be small or large; for example, one can speak of a block cipher with a message space of 128-bit strings, X={0,1}¹²⁸, or one can speak of a block cipher with a message space of 512-byte strings, X={0,1}⁴⁰⁹⁶. In either case, the block cipher might be tweakable or untweakable. According to the definitions in the preceding paragraph, the message space X of a block cipher may be any specified set of strings. Still, well-known block ciphers support only restricted domains. Indeed the message space of well-known block ciphers is always X={0,1}ⁿ for some small number n. The number n is called the “blocksize” of the block cipher. The most well known block ciphers are the algorithm of the Data Encryption Standard (DES), which has a blocksize of n=64 bits (8 bytes), and the algorithm of the Advanced Encryption Standard (AES), which has a blocksize of n=128 bits (16 bytes). These values of the blocksize are typical. Nowadays n=128 bits is regarded as the preferred value for the blocksize of a block cipher.

The term “conventional” block cipher means an untweakable block cipher E: K×X→X where X={0,1}ⁿ for n being a small number (like 64 or 128 bits). DES and AES are examples of conventional block ciphers. A conventional block cipher E cannot directly be used to encipher a 512-byte disk sector of a disk or, in general, to encipher any string having a length other than the one (short) length which is E's blocksize.

A block cipher (whether tweakable or untweakable) whose message space X includes “long” strings, such as 512-byte ones, is called a “wide-blocksize” block cipher. To solve the disk-sector encryption problem, a tweakable, wide-blocksize block cipher is the appropriate tool.

FIG. 1 illustrates some representations for block ciphers. Diagram 101 of FIG. 1 shows a conventional block cipher E: K×{0,1}ⁿ→{0,1}ⁿ being used to transform an n-bit plaintext P into an n-bit ciphertext C=E_{K}(P) under the control of a key K∈K. Diagram 102 of FIG. 1 shows a tweakable block cipher E: K×T×{0,1}ⁿ→{0,1}ⁿ transforming an n-bit plaintext P to an n-bit ciphertext C under control of the key K and tweak T. Diagram 103 of FIG. 1 depicts a wide-blocksize block cipher E: K×T×X→X being used to transform a plaintext P∈X into a ciphertext C∈X (where P and C have the same length) under the control of a key K∈K. The transformation may or may not depend on a tweak T∈ T. Notice that we have thickened the arrows associated to P and C to emphasize that the length of these strings is more than n bits for n the blocksize of a conventional blocksize.

Moving on to the representations for the backwards direction of block ciphers, diagram 201 of FIG. 1 shows D=E⁻¹,the inverse of the conventional block cipher E: K×{0,1}ⁿ→{0,1}ⁿ, being used to map an n-bit ciphertext C into an n-bit plaintext P=D_{K}(C)=E_{K}⁻¹(C) as controlled by a key K. Diagram 202 of FIG. 1 shows the identical process except that now we are using a tweakable block-cipher: the n-bit ciphertext C is being transformed into an n-bit plaintext P under the control of a tweak key K and tweak T. Diagram 203 of FIG. 1 depicts the inverse D=E⁻¹ of a wide-blocksize block cipher E: K×T×X→X being used to transform a ciphertext C∈X into a plaintext P∈X (where P and C have the same length) under the control of a key K and optional tweak T.

### Strong Block Ciphers and Weak Block Ciphers

There are many possible notions of security for a block-cipher. The most stringent requirement that is commonly considered is security in the sense of a “strong pseudorandom permutation” (PRP). The version of this notion appropriate for tweakable block-ciphers was introduced by Liskov, Rivest, and Wagner in their paper “Tweakable Block Ciphers”, which appears in “Advances in Cryptology”, CRYPTO '02, Lecture Notes in Computer Science, vol. 2442, pp. 31-46, 2002, incorporated herein by reference.

Let E: K×T×X→X be a tweakable block-cipher and let D be its inverse. Then E is regarded as “secure” in the sense of a strong PRP if no computationally reasonable adversary can do a good job to distinguish between the input/output behavior of the following two kinds of oracles:

1. “genuine-E-oracle”: At the very beginning, the oracle chooses a random key K from K. Subsequently, when the oracle is asked a query (Enc, T, P), for T∈T and P∈X, it returns E_{K}^{T}(P). If it is asked a query (Dec, T, C), for T∈T and C∈X, it returns D_{K}^{T}(C). To any other query it returns “invalid”.

2. random-permutation-oracle: At the very beginning, for every T∈T, the oracle chooses a random permutation Π^{T} having domain and range of X. Let Π_{T} denote the inverse permutation to Π^{T}. Now if the oracle is asked a query (Enc, T, P), for T∈T and P∈X, the oracle returns Π^{T}(P). If the oracle is asked a query (Dec, T, C), for T∈T and C∈X, it returns Π_{T}(C). To any other query the oracle returns “invalid”.

Informally, a block cipher is secure as a strong PRP if it any change to the plaintext (or the tweak that accompanies it) makes a completely unpredictable change to the associated ciphertext; and any change to the ciphertext (or the tweak that accompanies it) makes a completely unpredictable change to the associated plaintext. For example, if an adversary knows X, T, and E(K,X) it won't know anything about E(K,T,X′), where X′ is identical to X except for toggling the last bit, except that this is different from E(K,T,X). If an adversary knows Y, T, and D(K,T,Y) it won't know anything about D(K,T′,Y) or D(K,T,Y′), where T′ and Y′ differ from T and Y by toggling the last bit, except for the fact that the latter is different from D(K,T,Y).

A block cipher that is intended to achieve security in the sense of a strong PRP is called a “strong” block cipher. Conventional block ciphers like AES are strong block ciphers. A block cipher that is not intended to be a strong PRP, but to achieve some other, weaker property, is called a “weak” block cipher.

Many notions of security for weak block ciphers are possible, but weak block ciphers are sometimes less desirable in applications because of these weaker security properties. In an application such as disk-sector encryption use of a weak block cipher will afford the adversary additional avenues of attack. For example, it may be possible for the adversary to modify a first ciphertext in order to create a second ciphertext where the underlying plaintext for the second ciphertext is related to the underlying plaintext for the first ciphertext in an interesting way. Alternatively, it may be possible to use information learned about sector T in order to learn something about a sector T′ different from T. Such things are not possible when the block cipher used is a strong block cipher.

The notion of security thus described for a strong block cipher is applicable for both tweakable and untweakable block-ciphers: for that latter, simply consider the set of tweaks T to be the singleton set {ε}, as described before.

### Constructing Wide-Blocksize Block Ciphers

There are two approaches for constructing a wide-blocksize block cipher. One approach is to construct the wide-blocksize block cipher from scratch, making something that resembles a conventional block cipher such as DES or AES but which allows a larger plaintext block. The other method is to start from a conventional block cipher and use it in some specified manner in order to make the wide-blocksize block cipher. The latter approach is called a “mode of operation”.

The from-scratch approach has major drawbacks. In particular, it is difficult to construct block ciphers that have well-believed security properties, only a few such block ciphers are in widespread use, and all of them are conventional block ciphers. The problem is that the construction of block ciphers from scratch remains as much art as science, since the main “evidence” one can offer for the security of a from-scratch block cipher is the failure of people to find effective attacks. It is therefore considered preferable not to try to make a cryptographic object like as a wide-blocksize block cipher from scratch, but to rely instead on a well-studied, conventional block cipher.

The second approach, the mode-of-operation approach, has often been used for constructing wide-blocksize block ciphers. Well-known modes of operation include ECB, CBC, CFB, and OFB modes, as described in books such as that of Menezes, van Oorschot and Vanstone, “Handbook of Applied Cryptography”, published by CRC Press in 1997. Each of these modes may be used as a wide-blocksize block cipher. Let us consider two of these modes in more detail: ECB mode and CBC mode. Both modes start off with a conventional block cipher E: K×{0,1}ⁿ→{0,1}ⁿ and convert it into a wide-blocksize block cipher MODE[E]: K×({0,1}ⁿ)⁺→({0,1}ⁿ)⁺. The bracketed-E notation in E=MODE[E] serves to emphasize that the wide-blocksize block cipher E that we build depends on the conventional block cipher E. By ({0,1}ⁿ)⁺ we refer to the set of all binary strings whose length is a positive multiple of n bits. In other words, both ECB and CBC mode assume that the plaintext P on which we operate has a length that is a positive multiple m of the block-length n of the underlying conventional block cipher E.

For ECB mode, the plaintext P that we wish to encipher is partitioned into n-bit blocks P₁, P₂, . . . , Pₘ and then one separately enciphers each block Pᵢ under E_{K}. The concatenation of the resulting blocks is the ciphertext. The method just described is called “ECB encipherment” (using block cipher E) and it is denoted ECB[E]. The forward and backward direction of block cipher ECB[E] as shown in FIG. 2. There, and henceforth, the notation [a . . . b] is used to denote all the integers between a and b, including a and b.

For CBC mode, the plaintext P that one wishes to encrypt is partitioned into n-bit blocks P₁, P₂, . . . , Pₘ. One encrypts P by enciphering with EK the XOR of Pᵢ and the prior block of ciphertext Cᵢ₋₁. This is done for each i∈[1 . . . m]. For the very first block P₁, the prior block of ciphertext C₀ is taken to be a special value called the “initialization vector”, or IV. In order to regard CBC mode as a wide-blocksize block cipher (and not a length-increasing encryption scheme) one assumes that IV=0ⁿ (meaning the block of n zero-bits). The method just described is called “CBC encipherment” (using block cipher E) and it is denoted E=CBC[E]. The forward and backward direction of block cipher CBC[E] is thus as shown in FIG. 3. There, and henceforth, the symbol E is used to denote the XOR (exclusive or) operation.

The modes of operation just described, ECB and CBC, are wide-blocksize block ciphers that have been constructed from a conventional block cipher. However, neither of the two modes is secure in the sense of a strong PRP; they are weak wide-blocksize block ciphers and not strong wide-blocksize block ciphers. Regardless of the conventional block cipher E, it will be easy for an adversary to distinguish between a genuine-E-oracle and a random-permutation-oracle when either E=ECB[E] or E=CBC[E]. Indeed any wide-blocksize block cipher for which the first bit of ciphertext does not depend on every bit of plaintext is necessarily insecure as a strong block-cipher; an adversary can always distinguish a genuine-E-oracle from a random-permutation-oracle easily. For an effective attack, the adversary toggles the last bit of any multi-block plaintext and looks to see if this affects the first bit of the resulting ciphertext. If it does, the adversary knows for sure that it has a random-permutation-oracle; otherwise, the adversary guesses that it has a genuine-E-oracle.

We emphasize that modes of operation like ECB[E] and CBC[E] do qualify as (wide-blocksize) block ciphers. They have useful security characteristics, but they do not have the security characteristic of being a strong block cipher: they are weak (wide-blocksize) block ciphers, instead.

Not only ECB and CBC, but every well-known mode of operation fails to give a strong, wide-blocksize block cipher. Instead, ECB, CBC, and other well-known modes of operation can be considered as tools for constructing a strong wide-blocksize block cipher.

Despite the failure of common modes to provide a strong wide-blocksize block cipher, there does exist in the cryptographic literature an approach for making a strong wide-blocksize block cipher. For example, see the paper of M. Naor and O. Reingold that is entitled “On the Construction of Pseudo-Random Permutations: Luby-Rackoff Revisited” from the “Journal of Cryptology”, vol. 12, no. 1, pp. 29-66, 1999, incorporated herein by reference. The same authors also have an unpublished companion paper entitled “A pseudo-random encryption mode”, which is available on the web page of author Moni Naor.

Naor and Reingold teach the following approach for producing a wide-blocksize block cipher E^{NR}: (J×K×J)×X→X starting from a conventional block cipher E: K×{0,1}ⁿ→{0,1}ⁿ. To compute E^{NR}_{J K L}(P) first one takes the plaintext P and hashes it using a permutation H_{J}: X→X drawn from a family of possible permutations H={H_{J}: X→X}_{J∈J}. The family H is said to be a “universal” family of hash functions. The portion of the key called J names the particular permutation H_{J} that is to be used. Many permutations are possible, each having domain and range X and each named by some key J∈J. Hashing P produces an intermediate value PPP=H_{J}(P). Next one enciphers PPP using a weak wide-blocksize block cipher E. The weak, wide-blocksize block cipher E can be built from a conventional block cipher E. For example, one might encipher PPP with E_{K} where E=ECB[E]. The enciphering step produces an intermediate value CCC=E_{K}(PPP). Finally, one takes the intermediate value CCC and hashes it using the inverse of a permutation H_{L}: X→X drawn from a family of possible permutations H={H_{L}: X→X}_{L∈L}. That is, the portion of the key known as L names the particular function H_{L} whose inverse, applied to CCC, gives the final ciphertext, C=H_{L}⁻¹(CCC)=E^{NR}_{J K L}(P)=H_{L}⁻¹(E_{K}(H_{J} (P))). For an illustration of the Naor-Reingold technique see FIG. 4. Diagram 301 of FIG. 2 depicts enciphering under E^{NR}=NR[E,H]. Diagram 302 of FIG. 2 depicts deciphering by the inverse construction DNR. Since H_{J}, E_{K}, and H_{L}⁻¹ are all permutations, deciphering proceeds in the natural way, using the inverses of each of the component permutations.

In their “Journal of Cryptology” paper cited above, Naor and Reingold give sufficient conditions on the function family H and the weak, wide-blocksize block cipher E in order to ensure that the resulting wide-blocksize block cipher E^{NR}=NR[E,H] that they construct will be a strong block cipher.

There are several difficulties with using the Naor-Reingold approach. The main difficulty is that there is no known way to realize the family of permutations H in such a way that H_{K} and H_{L}⁻¹ will be simple and efficiently computable, both in hardware and in software, and yet the Naor-Reingold construction using H will give a strong block cipher. It is unspecified in the papers of Naor and Reingold what exactly one should choose H. Though much is known about how one might realize function families of this kind, the known art does not teach any techniques that are simple and efficient, both in hardware and software.

There are some additional difficulties with realizing the Naor-Reingold approach. One is the lack of any tweak T. Another limitation is that the Naor-Reingold method uses key material beyond that used by the underlying block cipher E; one would prefer a method that did not.

### BRIEF SUMMARY OF THE INVENTION

To overcome the foregoing and other difficulties, the present invention does not use the Naor-Reingold approach, but likewise constructs a strong block cipher out of a weak block cipher or a conventional block cipher. More particularly, one aspect of the invention is to construct a strong, wide-blocksize block ciphers from weak, wide-blocksize block ciphers. Another aspect of the invention is to construct a strong, wide-blocksize block cipher from a conventional block cipher.

The wide-blocksize block cipher constructed using the inventive methods will enjoy some or all of the following characteristics: (1) simplicity; (2) the ability to accommodate a tweak T; (3) economy of conventional block-cipher invocations; (4) avoiding the use of a universal hash-function family; (5) security in the sense of a strong, tweakable PRP; (6) operating on long strings, such as 512-byte ones; (7) operating on strings of multiple different lengths; (7) utilizing only a single key, that one key being used to key all calls to the conventional block cipher; (8) using only the forward direction of the conventional block cipher when the constructed block cipher enciphers a plaintext, and using only the reverse direction of the conventional block cipher when the wide-blocksize block cipher deciphers a ciphertext; (9) extreme symmetry, with deciphering being identical to enciphering except for using the backward direction of the underlying block cipher instead of the forward direction; (10) parallelizability (it being possible to simultaneously carry out an unbounded amount of the needed computation); and (11) suitability for both hardware and software realizations.

The present invention achieves one or more of these goals by constructing a wide-blocksize cipher out of a wide-blocksize block cipher or out of a conventional block cipher. In general terms, an embodiment of the present invention, which is referred to herein as “Encipher/Mask/Decipher” or “EMD”, comprises the following steps:

[Step 1: Encipher] Begin by taking the (possibly long) plaintext P and enciphering it using a weak, wide-blocksize block cipher E. The result of this step is the intermediate value PPP. This step may depend on a tweak T.

[Step 2: Mask] Next, “mix” the bits of the intermediate value PPP to get an intermediate value CCC of the same length as PPP. The mixing may depend on a tweak T. The terms “mix” or “mask” are used interchangeably herein to describe this step. Mixing should be a computationally cheap process, preferably involving few or no calls to a conventional block cipher. Additionally, mixing must diffuse across CCC the bits of PPP.

[Step 3: Decipher] Finally, apply to CCC the deciphering method, D, of the weak, wide-blocksize block cipher E. The result of this operation is the final ciphertext C. This step may again depend on the tweak T.

In one mode, referred to herein as “CBC/Mask/CBC” or “CMC”, the mechanism comprises a pass of CBC encryption, a lightweight masking step, and then a pass of CBC decryption. In another mode, referred to herein as “ECB/Mask/ECB” or “EME”, the mechanism comprises a pass of modified ECB encryption, a lightweight masking step, and then a pass of modified ECB decryption. Unlike the CMC mode which is inherently serial because it is based on CBC, the EME mode is fully parallelizable.

In one embodiment, a method for enciphering a plaintext according to the present invention comprises enciphering the plaintext with a weak, wide-blocksize block cipher to produce an intermediate value; masking the intermediate value to produce a masked intermediate value; and deciphering the masked intermediate value using a weak, wide-blocksize, block cipher.

In another embodiment, a method to encipher a plaintext into a ciphertext according to the present invention comprises forming an intermediate value by enciphering the plaintext with a first, weak block cipher that is keyed using a key; masking the intermediate value to produce a masked intermediate value; and computing the ciphertext by deciphering the masked intermediate value using a second, weak, block cipher that is keyed using said key.

In a further embodiment, a method to encipher a plaintext into a ciphertext according to the invention comprises enciphering the plaintext with a weak block cipher to form an intermediate value; masking the intermediate value; and enciphering the intermediate value with a weak block cipher.

In a still further embodiment, a strong, wide-blocksize block cipher for enciphering a plaintext into a ciphertext according to the present invention comprises computing an intermediate value by enciphering the plaintext with a first, weak, wide-blocksize block cipher; forming a mask from at least the intermediate value; combining the intermediate value and the mask to produce a masked intermediate value; and computing the ciphertext by deciphering the masked intermediate value using a second, weak, wide-blocksize block cipher.

In another embodiment, a method of enciphering by a wide-blocksize block cipher having a blocksize of mn bits, wherein the wide-blocksize block cipher is constructed using a conventional block having a blocksize of n bits, comprises using the conventional block cipher in a mode of operation to compute an intermediate value; masking the intermediate value; and using the conventional block cipher in a mode of operation to compute the final ciphertext.

In a still further embodiment of the invention, a method of producing a wide-blocksize block cipher from a conventional block cipher comprises converting the conventional block cipher into a first, weak, wide-blocksize block cipher using a first mode of operation of said conventional block cipher; converting the conventional block cipher into a second, weak, wide-blocksize block cipher using a second mode of operation of said conventional block cipher; and transforming the output of the first mode of operation into the input of the second mode of operation by a mixing operation.

In another embodiment of the present invention, a method to protect the privacy of data stored on a mass-storage device which is organized into a sequence of sectors, each sector having a unique sector index, some or all of the sectors being ciphertexts, each ciphertext being the encryption of a plaintext under a given key and depending on the sector index, comprises forming each said ciphertext by using a block-cipher mode of operation to transform the plaintext into an intermediate value; mixing the bits of the intermediate value using a mixing transformation; and using a block-cipher mode of operation to transform the mixed intermediate value into the ciphertext.

Another embodiment of the invention is a computer-readable storage medium that stores instructions that when executed by a computer cause the computer to encipher a plaintext according to the operations comprising enciphering the plaintext with a weak, wide-blocksize block cipher to produce an intermediate value; masking the intermediate value to produce a masked intermediate value; and deciphering the masked intermediate value using a weak, wide-blocksize, block cipher.

A further embodiment of the invention is a wide-blocksize block-cipher enciphering apparatus that is configured to use a conventional block cipher and a key to encipher a plaintext into a ciphertext, comprising a programmable computer; and programming executable on said computer for carrying out the operations of enciphering the plaintext with a weak, wide-blocksize block cipher to produce an intermediate value; masking the intermediate value to produce a masked intermediate value; and deciphering the masked intermediate value using a weak, wide-blocksize, block cipher.

In still another embodiment of the invention, a secure disk drive is organized into a sequence of sectors, the contents of some or all of the sectors are encrypted depending on a key, a plaintext value, and the index of the sector within the sequence of sectors, and at least one said sectors is encrypted by enciphering plaintext using a first enciphering scheme which forms an intermediate value; masking the bits of the intermediate value and forming a masked intermediate value; and deciphering the masked intermediate value using a second enciphering scheme which thereby forms the encrypted sector.

In another embodiment of the invention, an enciphering method comprises computing a first intermediate value from a plaintext; computing a mask from the first intermediate value; computing a second intermediate value from the first intermediate value and the mask; and computing a ciphertext from the second intermediate value. The ciphertext can be computed by reversing the procedure.

In another embodiment of the invention, an enciphering method comprises computing a first intermediate value from a ciphertext; computing a mask from the first intermediate value; computing a second intermediate value from the first intermediate value and the mask; and computing a plaintext from the second intermediate value. The plaintext can be computed by reversing the process.

Another embodiment of the invention is a block-cipher mode of operation for encrypting a plaintext comprising a layer of block-cipher invocations followed by a mixing layer followed by a second layer of block-cipher invocations.

Realizations of the methods described herein may be stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), ROMs (read-only memories), PROMs (programmable read-only memories), and computer instruction signals embodied in a transmission medium (with or without a carrier wave upon which the signals are modulated). The transmission medium may include a communications network, such as the Internet. Alternatively, the realizations of the methods described in this detailed description can be directly realized in hardware and by the firmware and finite state machines that direct the processing of that hardware.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

FIG. 1 illustrates conventional block ciphers and wide-blocksize ciphers, and further illustrates both tweakable block-ciphers and untweakable block-ciphers.

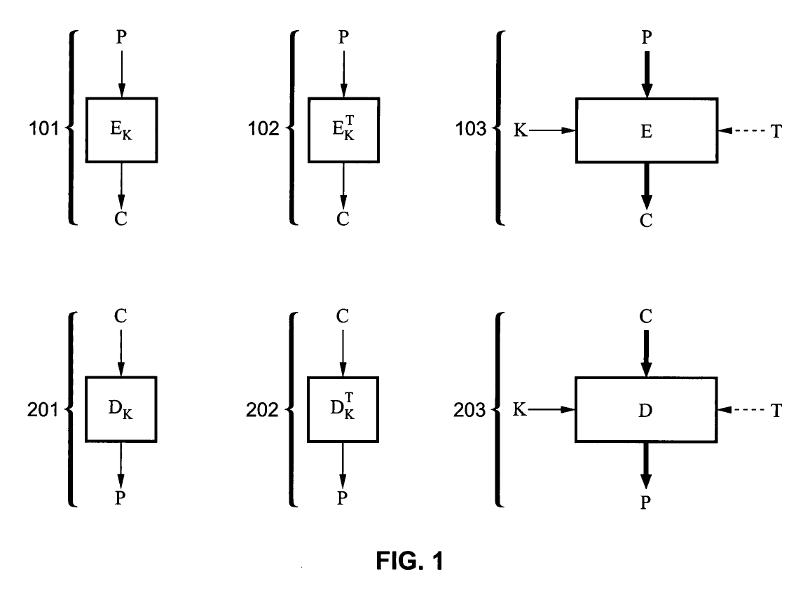

FIG. 2 is pseudocode illustrating a known enciphering method E=ECB[E] and deciphering method D=E⁻¹.

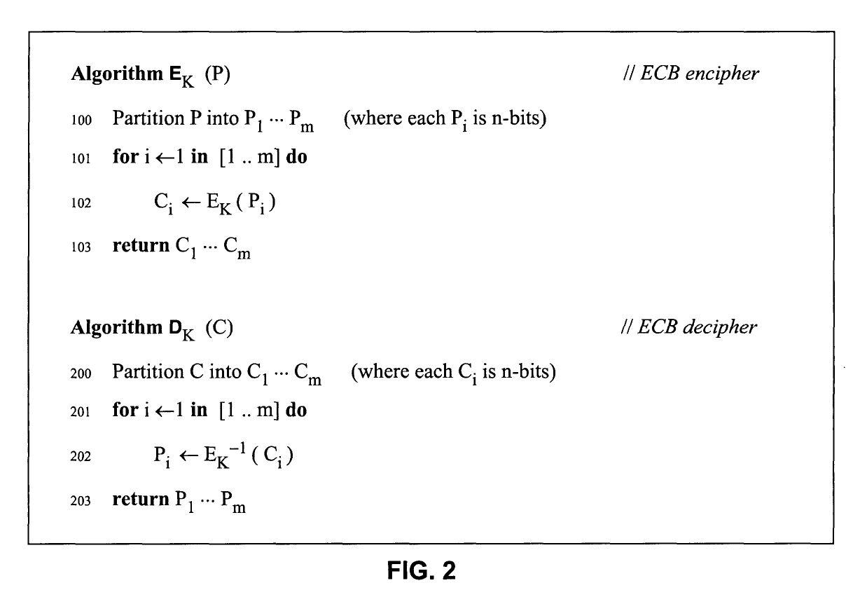

FIG. 3 is pseudocode illustrating a known enciphering method E=CBC[E] and deciphering method D=E⁻¹.

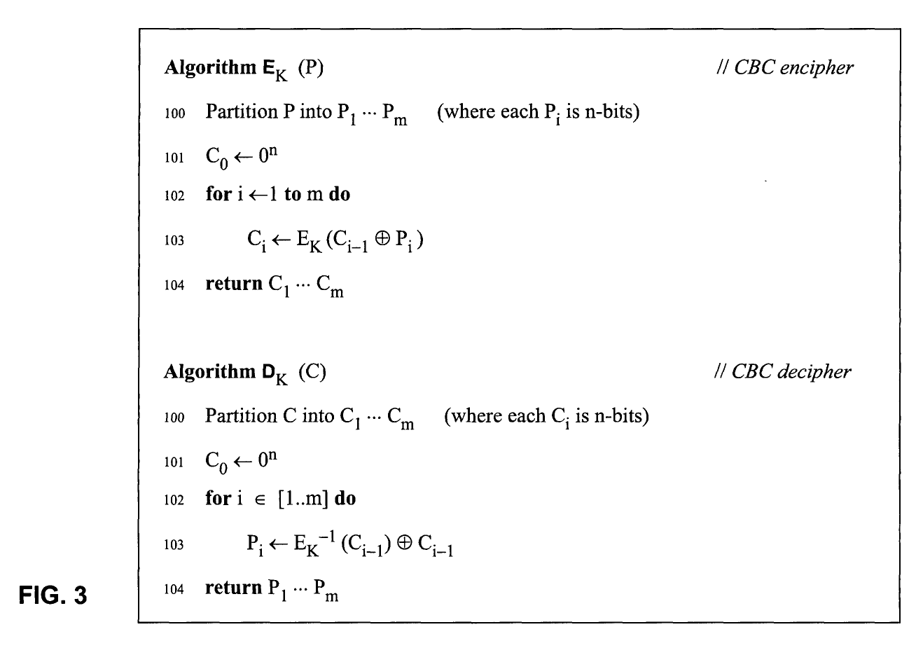

FIG. 4 illustrates the Naor-Reingold approach for constructing a wide-blocksize block cipher.

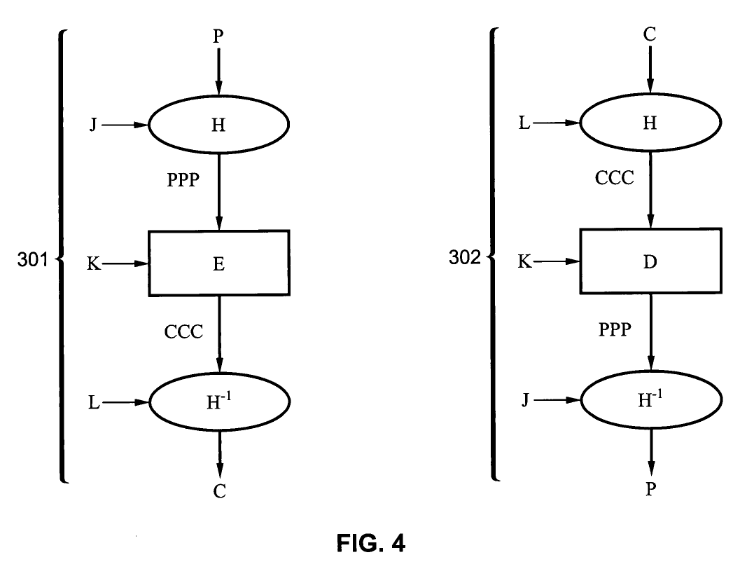

FIG. 5 is pseudocode illustrating a “double” algorithm for 128-bit strings.

FIG. 6 is pseudocode illustrating enciphering using E=CMC[E] according to the present invention.

FIG. 7 illustrates enciphering under CMC according to the present invention.

FIG. 8 is pseudocode illustrating deciphering using the backwards direction D=E⁻¹ of E=CMC[E] according to the present invention.

FIG. 9 illustrates deciphering under CMC according to the present invention.

FIG. 10 illustrates a generic method for rendering tweakable an untweakable enciphering scheme according to the present invention.

FIG. 11 is pseudocode illustrating enciphering with a tweakable version of CMC[E] according to the present invention.

FIG. 12 is pseudocode illustrating enciphering using E=EME[E] according to the present invention.

FIG. 13 illustrates EME according to the present invention.

FIG. 14 is pseudocode illustrating deciphering using the backwards direction D=E⁻¹ of E=EME[E] according to the present invention.

FIG. 15 illustrates a variant of EME according to the present invention, wherein the mode is constructed using a tweakable n-bit block cipher instead of an untweakable n-bit block cipher.

### DETAILED DESCRIPTION OF THE INVENTION

Referring more specifically to the drawings, for illustrative purposes the following description is presented to enable any person skilled in the art to make and use the invention. Various modifications to the disclosed embodiments will be readily apparent to those skilled in the art, and the general principles defined herein may be applied to other embodiments and applications without departing from the spirit and scope of the present invention. Thus the present invention is not intended to be limited to the embodiments shown, but is to be accorded the widest scope consistent with the principles and features disclosed herein.

The general approach for making a wide-blocksize block cipher out of a wide-blocksize block cipher or out of a conventional block cipher according to the present invention can be described in terms of the following three steps, the combination of which is referred to herein as “Encipher/Mask/Decipher” or “EMD”. Two modes of operation will also be described herein; the first is referred to herein as “CBC/Mask/CBC” or “CMC”, and the second is referred to herein as “ECB/Mask/ECB” or “EME”.

[Step 1: Encipher] The method begins by taking the (possibly long) plaintext P and enciphering it using a weak wide-blocksize block cipher. The result of enciphering P under the weak wide-blocksize block cipher is the intermediate value PPP. The enciphering step might be tweakable (as in the tweakable version of CMC described below) or it might not be.

[Step 2: Mask] This step is to “mix” the intermediate value PPP, applying some length-preserving permutation to it. The permutation might depend on the key (as it does with EME) or it might not (as with CMC). The step might depend on a tweak (as it does with EME) or it might not (as with CMC). The masking step should be cheap—operations like XOR, shifts, and a small number of block-cipher calls. This step must be reversible.

[Step 3: Decipher] Finally, one applies to CCC the deciphering method of a weak, wide-blocksize block cipher. The result of this operation is the final ciphertext C. The step might depend on a tweak, or it might not.

There are different ways to conceptualize the same basic process. The combination of the Encipher in Step 1 and the Mask in Step 2 is itself a form of Enciphering. Lumping together these two operations would make the method look like “Encipher/Decipher”. Similarly, it is largely a matter of perspective when one is enciphering and when one is deciphering, and so the name “Encipher/Mask/Decipher” could also be termed the “Encipher/Mask/Encipher”, where one considers the third step in the process to be an enciphering step rather than a deciphering step; it is fundamentally arbitrary if one thinks of the third step as deciphering with one block cipher or as enciphering with its inverse.

### Finite-Field Multiplication

Before describing the present invention in more detail, it will be helpful to explain a well-known operation, “double”, that can be used within the mixing (also called masking) step of the present invention. First, fix a number n that will be the blocksize of a conventional block cipher E: K×{0,1}ⁿ→{0,1}ⁿ. Now by “double”: {0,1}ⁿ→{0,1}ⁿ we mean the function that does the following: (i) it takes an n-bit binary string S=sₙ₋₁ . . . s₁ s₀; (ii) it regards that string as a degree n−1 polynomial S(x)=sₙ₋₁xⁿ⁻¹+ . . . +s₁x+s₀; (iii) it multiplies this polynomial by the formal variable x in order to produce a degree n polynomial sₙ₋₁ xⁿ+ . . . +s₁ x²+s₀x; (iv) it reduces this degree n polynomial modulo a fixed, irreducible, degree-n polynomial Pₙ(x) in order to create a degree n−1 polynomial R(x)=rₙ₋₁ xⁿ⁻¹+ . . . +r₁ x+r₀; and (v) it converts the resulting polynomial R(x) back into binary notation, R=rₙ₋₁ . . . r₁ r₀, which is the final result double(S).

The operation “double” can be summarized as “multiply S by the constant x in the finite field with 2ⁿ points”. This operation is well known in the art. We will alternatively write the operation double(S) as 2S (since multiplying by x is multiplying by 2 under the standard representation of field points). Do not confuse this operation 2S with multiplication of integers: S is not regarded as an integer and 2S is not obtained by doubling some integer in the ring of integers.

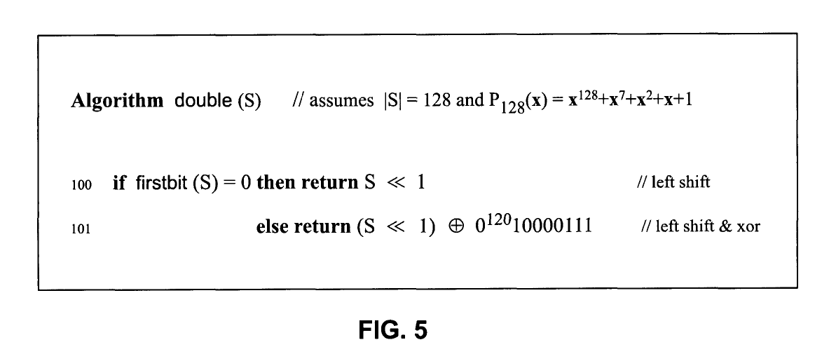

FIG. 5 illustrates the method for doubling S when n=128 and the irreducible polynomial is P₁₂₈(x)=x¹²⁸+x⁷+x²+x+1. Multiplying S=s₁₂₇ . . . s₁ s₀ by the formal polynomial x gives the polynomial s₁₂₇x¹²⁸+s₁₂₆x¹²⁷+ . . . +s₁x²+a₀x that must now be reduced modulo x¹²⁸+x⁷+x²+x+1. Thus, if the first bit of S, namely s₁₂₇, is 0 then 2S is just S<<1, where S<<1 is the left shift of S by 1 bit (with a 0 coming into the last bit and the first bit vanishing). If the first bit of S is 1 then we must add x¹²⁸ to S<<1. Since x¹²⁸ =x⁷+x²+x+1 adding x¹²⁸ means to XOR by 0¹²⁰10000111. In summary, when n=128 and the indicated irreducible degree-128 polynomial is used, the method shown in FIG. 5 can be used to compute double(S).

As indicated above, one may write 2S for double(S). Likewise, one may write 4S or 2²S for double(2S)=2(2S); one may write 8S or 2³ S for double(4S)=2(4S), and so forth. That is, for i>0 define 2ⁱ S as 2(2ⁱ⁻¹S), defining 2⁰ S=1S=S. This definition of 2ⁱ S agrees with the usual definition for multiplication in the finite field with 2ⁿ points.

### CMC Mode

A preferred mode of the EMD method described above is referred to herein as “CBC/Mask/CBC” or “CMC”, which comprises a pass of CBC encryption, a lightweight masking step, and then a pass of CBC decryption. The CMC mode will now be described in more detail.

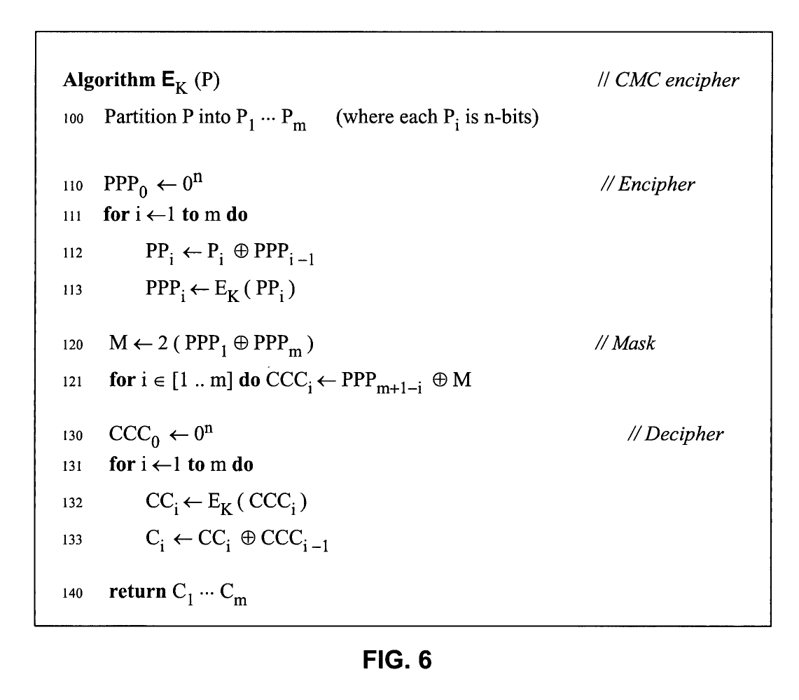

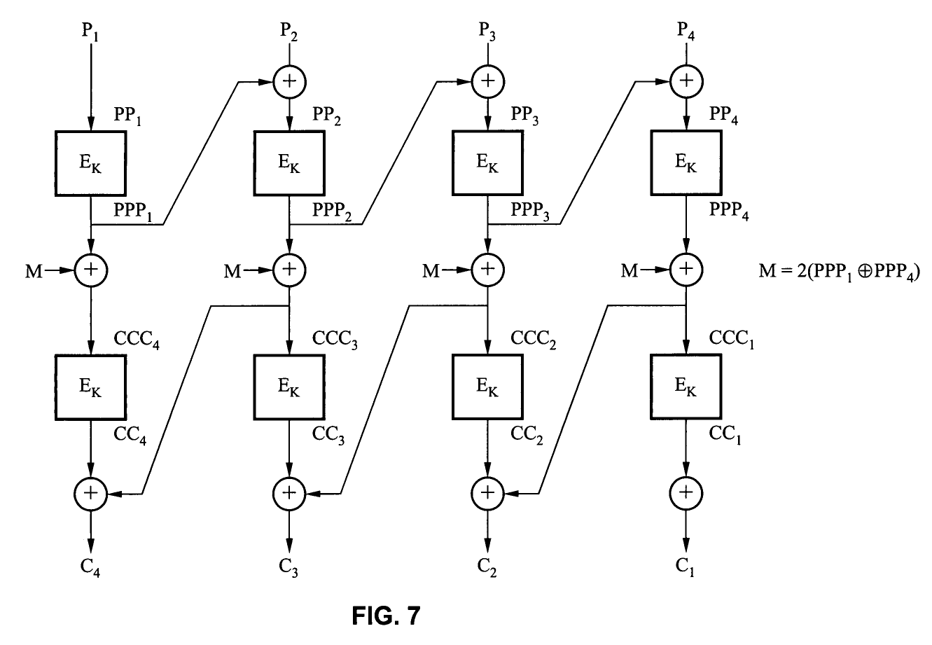

Starting with a conventional block cipher E: K×{0,1}ⁿ→{0,1}ⁿ and a number m≧2, the CMC mode of operation provides a wide-blocksize block cipher E=CMC[E] that has signature E: K×{0,1}ⁿ×{0,1}^{m n}→{0,1}^{m n}. That is, the key space for E=CMC[E] is the key space K of the underlying conventional block cipher E and the message space for E is X={0,1}^{n m}. Enciphering under E=CMC[E] is specified in FIG. 6, and an illustration of CMC[E] encipherment is provided in FIG. 7 for the specific case of messages that have m=4 blocks.

FIG. 7 is best understood in conjunction with the algorithm definition in FIG. 6, which explains all of the figure's various parts. From those figures, it can be seen that the plaintext P is partitioned into n-bit blocks P₁ . . . Pₘ. The string P₁ . . . Pₘ is then CBC-enciphered (CBC encryption with a zero IV) to get the intermediate value PPP=PPP₁ . . . PPPₘ which is the concatenation of m intermediate blocks. An n-bit string M, which is referred to herein as the “offset” or “mask”, is then computed from the sequence of intermediate blocks. The value is computed by XORing together the first intermediate block PPP₁ and the last intermediate block PPPₘ and then doubling the result. Doubling is by the operation “double” previously defined above. Now, the mask M is XOR-ed with each intermediate block from PPP₁ . . . PPPₘ, the result being the sequence of masked intermediate blocks CCCₘ . . . CCC₁. Note that the order of indexing has been reversed, which helps to “symmetrize” the CMC technique, making enciphering and deciphering the same algorithm but using the alternative orientation of the underlying conventional block cipher. The final step is to CBC-decipher CCC=CCC₁ . . . CCCₘ using E⁻¹ as the underlying block cipher. Note that the block-cipher invocations associated to CBC deciphering can all be done in parallel, but the block-cipher invocations associated to CBC enciphering cannot be done in parallel.

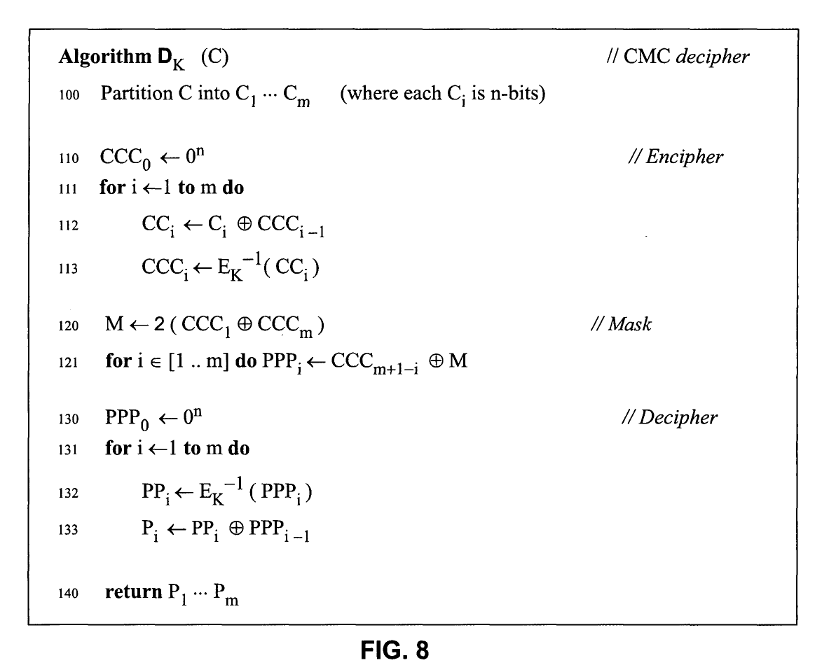

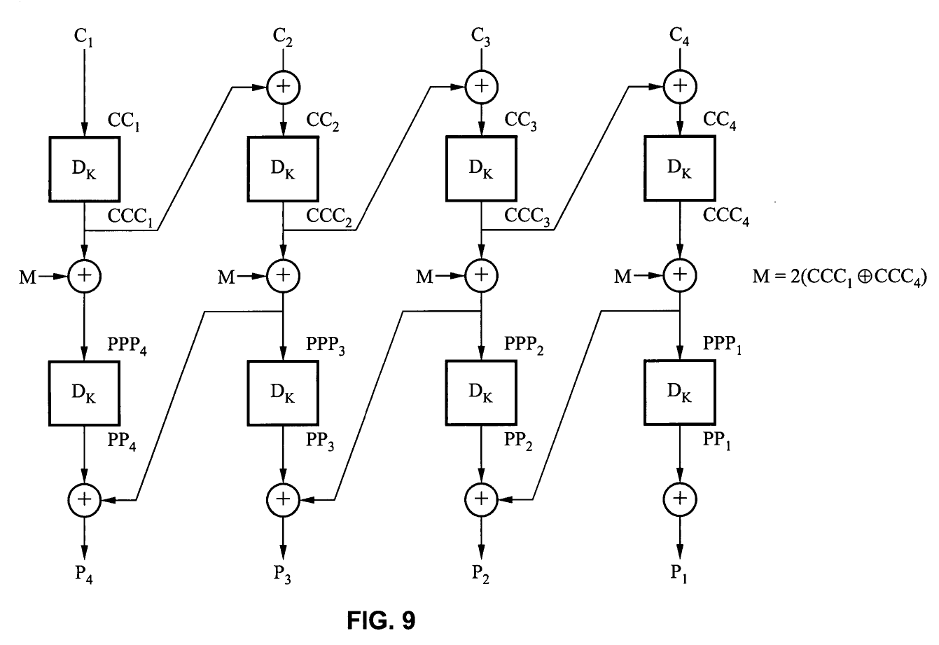

FIG. 8 and FIG. 9 depict the deciphering process associated to the wide-blocksize block cipher CMC[E]. FIG. 9 is best understood in conjunction with the algorithm definition in FIG. 8, which explains all of the figure's various parts. From those figures, one can see that, to decipher, the ciphertext C is partitioned into n-bit blocks C₁ . . . Cₘ. The string C₁ . . . Cₘ is then CBC-enciphered using the block cipher E⁻¹ in order to get the intermediate value CCC=CCC₁ . . . CCCₘ. The n-bit that is mask M is computed from this sequence of blocks. The value is computed by XORing together the first intermediate value CCC₁ and the last intermediate value CCCₘ and then doubling the result. Now, M is XOR-ed with each block from CCC₁ . . . CCₘ, the result being the sequence of masked intermediate values PPPₘ . . . PPP₁. Again, the order of indexing has been reversed. The last step is to CBC-decipher PPP=PPP₁ . . . PPPₘ using E as the underlying block cipher.

To see that deciphering a ciphertext recovers the original plaintext it is necessary to observe that the mask M computed from PPP₁ . . . PPPₘ will be identical to the mask M computed from CCC₁ . . . CCCₘ. To see this, note that

| | |
|---|---|
| M | = 2 (PPP₁ ⊕ PPPₘ) // as computed when enciphering |
| CCC₁ | = PPPₘ ⊕ M |
| CCCₘ | = PPP₁ ⊕ M |
| M | = 2 (CCC₁ ⊕ CCCₘ) // as computed when deciphering |
| | = 2 (PPPₘ ⊕ M ⊕ PPP₁ ⊕ M) |
| | = 2 (PPP₁ ⊕ PPPₘ) |

which is indeed the same as the mask computed by the enciphering direction of the constructed wide-blocksize block cipher.

### Making the Scheme Tweakable

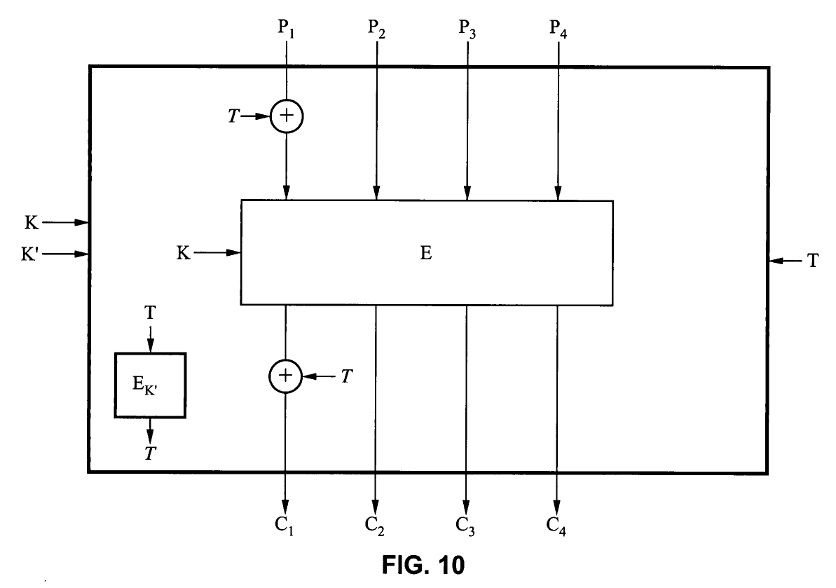

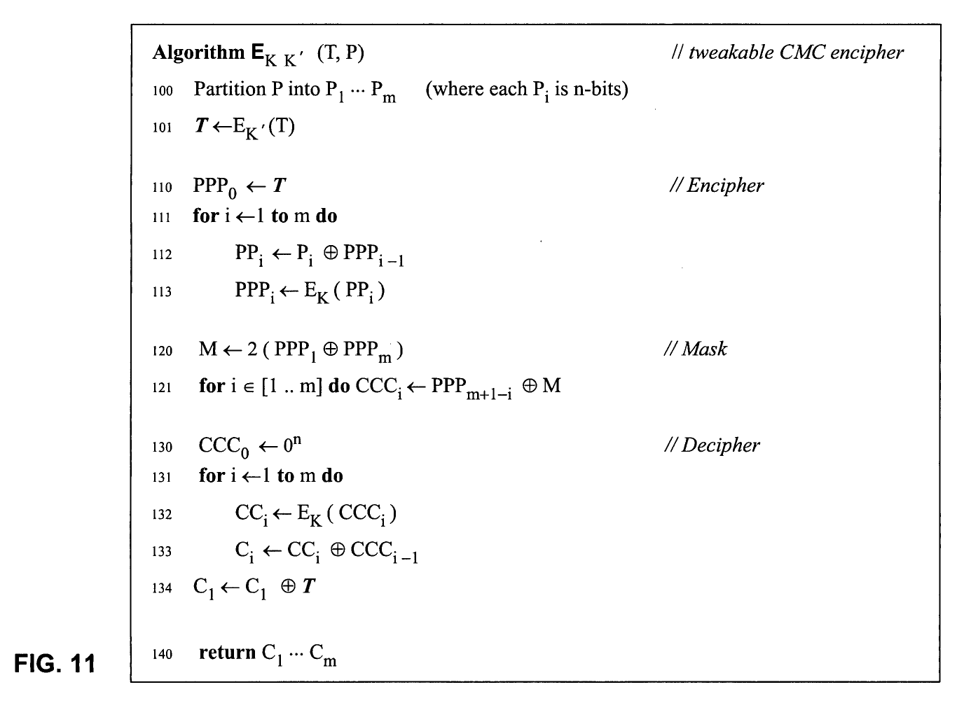

Referring to FIG. 10 and FIG. 11, a method for supporting a tweak in CMC mode will now be described and, more generally, an exemplary method to add in support of a tweak to any untweakable, wide-blocksize block cipher.

Assume that one wishes to support tweaks that are n-bit strings and further assume that one has already defined an untweakable wide-blocksize block cipher (like CMC[E]) having a signature E: K×{0,1}^{nm}→{0,1}^{nm} where m≧1. Assume that one has in hand a block cipher E: K×{0,1}ⁿ→{0,1}ⁿ. Then define from E and E a tweakable wide-blocksize block cipher E^{TW}: (K×K)×{0,1}ⁿ×0,1}^{nm}→{0,1}^{nm} by saying that one computes E^{TW}_{KK′}(T, P) as follows:

(a) Let T=E_{K}(T),

(b) Then XOR T into the first block of P to make a modified plaintext P′.

(c) Then apply the untweakable block cipher E_{K} to P′ to give C′.

(d) Now XOR T into the first block of C′ to give the final ciphertext, C.

For the particular case of CMC, the tweak-supporting algorithm would encipher as shown in FIG. 11, while the deciphering algorithm would work in the natural way corresponding thereto.

### EME Mode

A second mode of the EMD method described above is referred to herein as “ECB/Mask/ECB” or “EME”. Unlike the CMC mode, which is inherently serial because it is based on CBC, the EME mode is fully parallelizable. The EME mode will now be described.

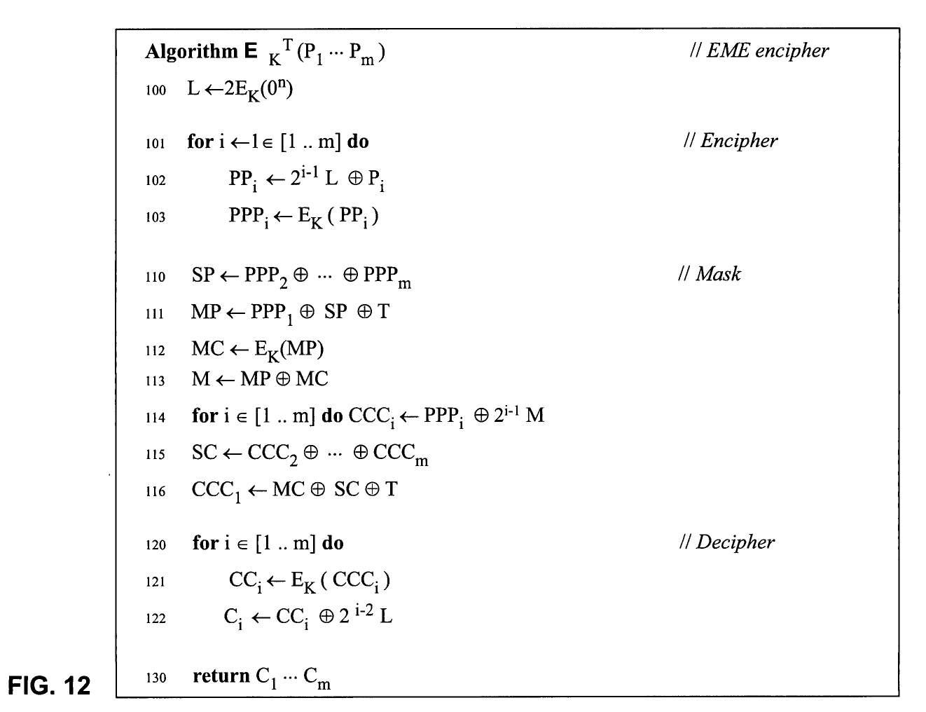

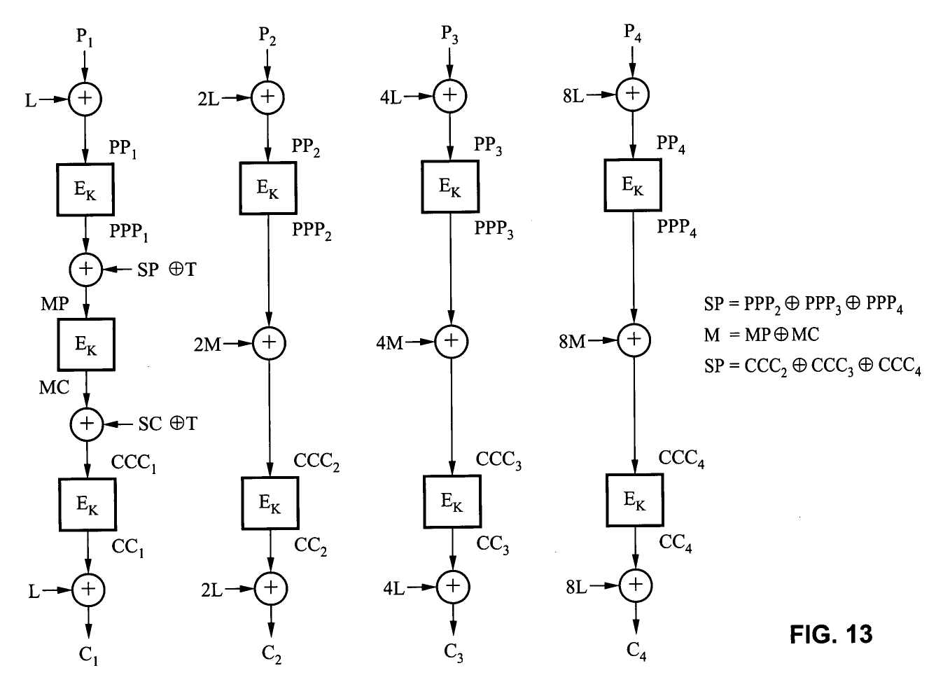

Starting with a conventional block cipher E: K×{0,1}ⁿ→{0,1}ⁿ and a number m≧2, the EME mode of operation provides a tweakable, wide-blocksize block cipher E=EMD[E] where E: K×{0,1}ⁿ×{0,1}^{m n}→{0,1}^{m n}. That is, the key space remains the key space K of the underlying conventional block cipher; the set of allowed tweaks is T={0,1}ⁿ; and the message space is X={0,1}^{n m}. (More generally, the message space may be considered as the set of all strings that are a positive multiple of n bits.) Note that this time we have added in the tweak from the beginning, which helps facilitate the smaller key space K and allows that all block-cipher calls be oriented in the same direction. Enciphering under EME[E] is specified in FIG. 12 and an illustration of EME encipherment is given in FIG. 13. The plaintext P must be a multiple of n bits and it is written as P=P₁ . . . Pₘ.

FIG. 13 is best understood in conjunction with the algorithm definition in FIG. 12, which explains all of the figure's various parts. From those figures, one can see that the plaintext P=P₁ . . . Pₘ is offset using values L, 2L, 4L, to form the corresponding sequence of blocks PP₁ . . . PPₘ. The value L is derived from the key K. The next step is to ECB encipher PP=PP₁ . . . PPₘ to get the intermediate value PPP, which is itself a sequence of blocks PPP=PPP₁ . . . PPPₘ. This completes the first step of the EMD method.

For the mixing step, XOR together the m n-bit blocks of PPP and the tweak T, apply the block cipher, and form the value M by XORing together the input and output from this block-cipher call. The value M so constructed is then used to create offsets 2M, 4M, 8M, . . . , which are XOR-ed with PPP₂ . . . PPPₘ to make CCC₂ . . . CCCₘ. The first value, CCC₁, is computed slightly differently. This creates a masked intermediate value CCC₁ . . . CCCₘ and completes the second step of the EMD method.

The final step is to apply the block cipher to each CCCᵢ value and offset the result using offsets L, 2L, 4L, . . . . This step can be considered the inverse of the ECB-based enciphering algorithm used in the first step. The algorithm description is complete at this point.

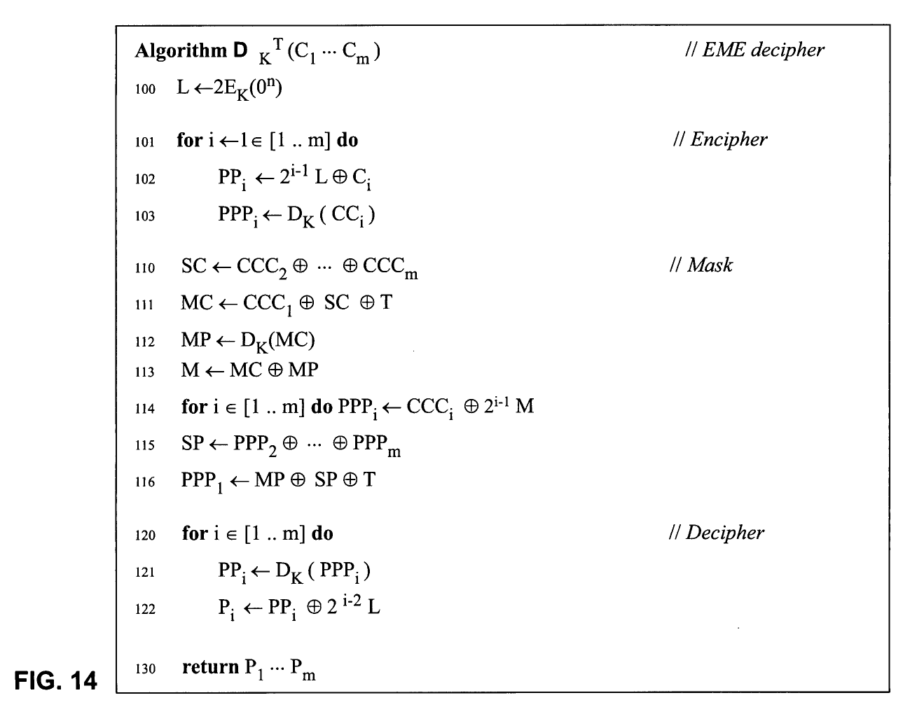

The deciphering process for EME proceeds in the natural way, as specified in FIG. 14. It is easy to check that deciphering a ciphertext with a given key and tweak recovers the original plaintext produced using that key and tweak.

### Design Startinq From a Tweakable n-Bit Block Cipher

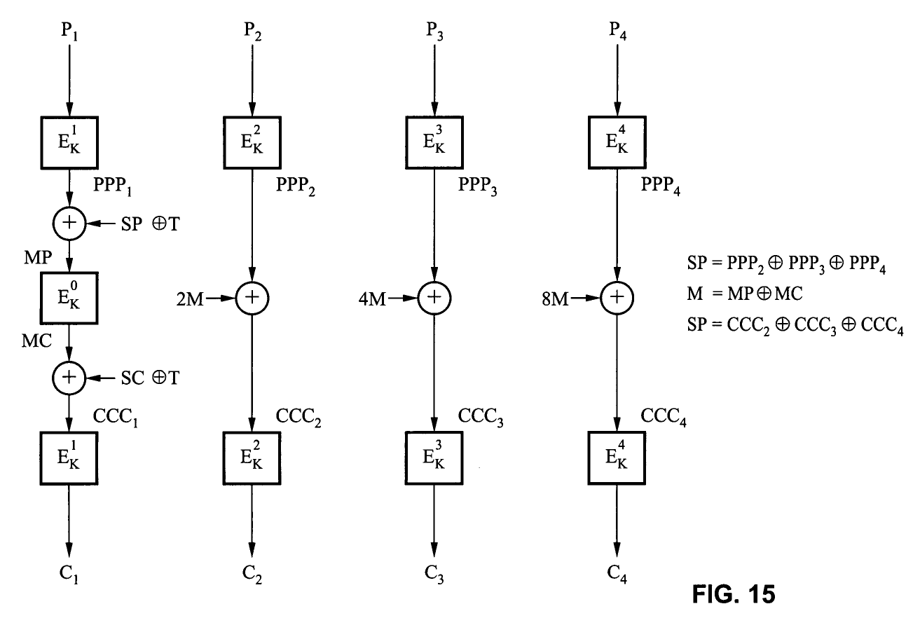

The discussion thus far has illustrated the construction of wide-blocksize block ciphers starting from a conventional block ciphers. CMC and EME consisted of one pass of the conventional block cipher operating in some mode of operation; a mixing step; and a second pass of the conventional block cipher operating in some mode of operation. One can also design wide-blocksize block ciphers starting from a tweakable block cipher. The approach is illustrated in FIG. 15, which gives a slight variant of EME. For the top layer, in place of XORing offset material and then enciphering, we apply a tweakable, n-bit block cipher. For the bottom layer, in place of enciphering and then XORing offset material, we apply a tweakable block cipher.

### Execution Vehicles

The enciphering and the deciphering process used by the present invention may reside, without restriction, in software, firmware, or in hardware. The execution vehicle might be a computer CPU, such as those manufactured by Intel Corporation and used within personal computers. Alternatively, the process may be performed within dedicated hardware, as would typically be found in a cell phone or a wireless LAN communications card or the hardware associated to a disk controller. The process might be embedded in the special-purpose hardware of a high-performance encryption engine. The process may be performed by a PDA (personal digital assistant), such as a Palm Pilot®. In general, any engine capable of performing a complex sequence of instructions and needing to provide privacy is an appropriate execution vehicle for the invention.

The various processing routines that comprise the present invention may reside on the same host machine or on different host machines interconnected over a network (e.g., the Internet, an intranet, a wide area network (WAN), or local area network (LAN)). Thus, for example, the enciphering of a message may be performed on one machine, with the associated deciphering performed on another machine, the two communicating over a wired or wireless LAN. In such a case, a machine running the present invention would have appropriate networking hardware to establish a connection to another machine in a conventional manner.

A principal application of a tweakable, wide-blocksize block cipher is to solve the disk-sector encryption problem, where one wants to encrypt the contents of a disk in order to protect user data. In this content, a “disk” should be understood as any mass-storage device with contents organized as a sequence of “sectors”. In particular, the technology used to implement a “disk”, whether it be a spinning magnetic platter, a magnetic tape, a solid-state device, an optical disk, or some other implementation technology, is not relevant to the current invention.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method to encipher a plaintext, comprising:
enciphering the plaintext with a weak, wide-blocksize block cipher to produce an intermediate value;
masking the intermediate value to produce a masked intermediate value; and
deciphering the masked intermediate value using a weak, wide-blocksize, block cipher.

2. A method as recited in claim 1, wherein the weak, wide-blocksize block cipher is a mode of operation of a conventional block cipher.

3. A method as recited in claim 1, wherein at least one of said steps depends on a tweak.

4. A method as recited in claim 1, wherein said masking step uses multiplication in a finite field.

5. A method as recited in claim 1, wherein said masking step uses a mask obtained by XORing together portions of the intermediate value.

6. A method to encipher a plaintext into a ciphertext, comprising:
forming an intermediate value by enciphering the plaintext with a first, weak block cipher that is keyed using a key;
masking the intermediate value to produce a masked intermediate value; and
computing the ciphertext by deciphering the masked intermediate value using a second, weak, block cipher that is keyed using said key.

7. A method as recited in claim 6, wherein the weak, block cipher is a mode of operation of a conventional block cipher.

8. A method as recited in claim 6, wherein at least one of said steps depends on a tweak.

9. A method as recited in claim 6, wherein said masking step uses multiplication in a finite field.

10. A method as recited in claim 6, wherein said masking step uses a mask obtained by XORing together portions of the intermediate value.

11. A method to encipher a plaintext into a ciphertext, comprising:
enciphering the plaintext with a weak block cipher to form an intermediate value;
masking the intermediate value; and
enciphering the intermediate value with a weak block cipher.

12. A method as recited in claim 11, wherein the weak block cipher is a mode of operation of a conventional block cipher.

13. A method as recited in claim 11, wherein at least one of said steps depends on a tweak.

14. A method as recited in claim 11, wherein said masking step uses multiplication in a finite field.

15. A method as recited in claim 11, wherein said masking step uses a mask obtained by XORing together portions of the intermediate value.

16. A strong, wide-blocksize block cipher for enciphering a plaintext into a ciphertext, comprising:
computing an intermediate value by enciphering the plaintext with a first, weak, wide-blocksize block cipher;
forming a mask from at least the intermediate value;
combining the intermediate value and the mask to produce a masked intermediate value; and
computing the ciphertext by deciphering the masked intermediate value using a second, weak, wide-blocksize block cipher.

17. A cipher as recited in claim 16, wherein the weak, wide-blocksize block cipher is a mode of operation of a conventional block cipher.

18. A cipher as recited in claim 16, wherein at least one of said steps depends on a tweak.

19. A cipher as recited in claim 16, wherein said masking step uses multiplication in a finite field.

20. A cipher as recited in claim 16, wherein said masking step uses a mask obtained by XORing together portions of the intermediate value.

21. A method of enciphering by a wide-blocksize block cipher having a blocksize of mn bits, wherein the wide-blocksize block cipher is constructed using a conventional block having a blocksize of n bits, comprising:
using the conventional block cipher in a mode of operation to compute an intermediate value;
masking the intermediate value; and
using the conventional block cipher in a mode of operation to compute the final ciphertext.

22. A method as recited in claim 21, wherein at least one of said steps depends on a tweak.

23. A method as recited in claim 21, wherein said masking step uses multiplication in a finite field.

24. A method as recited in claim 21, wherein said masking step uses a mask obtained by XORing together portions of the intermediate value.

25. A method of producing a wide-blocksize block cipher from a conventional block cipher, comprising:
converting the conventional block cipher into a first, weak, wide-blocksize block cipher using a first mode of operation of said conventional block cipher;
converting the conventional block cipher into a second, weak, wide-blocksize block cipher using a second mode of operation of said conventional block cipher; and
transforming the output of the first mode of operation into the input of the second mode of operation by a mixing operation.

26. A method as recited in claim 25, wherein at least one of said steps depends on a tweak.

27. A method to protect the privacy of data stored on a mass-storage device that is organized into a sequence of sectors, each sector having a unique sector index, some or all of the sectors being ciphertexts, each ciphertext being the encryption of a plaintext under a given key and depending on the sector index, comprising:
forming each said ciphertext by
using a block-cipher mode of operation to transform the plaintext into an intermediate value;
mixing the bits of the intermediate value using a mixing transformation; and
using a block-cipher mode of operation to transform the mixed intermediate value into the ciphertext.

28. A method as recited in claim 27, wherein at least one of said steps depends on a tweak.

29. A computer-readable storage medium, said storage medium storing instructions that when executed by a computer cause the computer to encipher a plaintext according to the operations comprising:
enciphering the plaintext with a weak, wide-blocksize block cipher to produce an intermediate value;
masking the intermediate value to produce a masked intermediate value; and
deciphering the masked intermediate value using a weak, wide-blocksize, block cipher.

30. A storage medium as recited in claim 29, wherein the weak, wide-blocksize block cipher is a mode of operation of a conventional block cipher.

31. A storage medium as recited in claim 29, wherein at least one of said operations depends on a tweak.

32. A storage medium as recited in claim 29, wherein said masking operation uses multiplication in a finite field.

33. A storage medium as recited in claim 29, wherein said masking operation uses a mask obtained by XORing together portions of the intermediate value.

34. A wide-blocksize block-cipher enciphering apparatus that is configured to use a conventional block cipher and a key to encipher a plaintext into a ciphertext, comprising:
a programmable computer; and
programming executable on said computer for carrying out the operations of
enciphering the plaintext with a weak, wide-blocksize block cipher to produce an intermediate value;
masking the intermediate value to produce a masked intermediate value; and
deciphering the masked intermediate value using a weak, wide-blocksize, block cipher.

35. An apparatus as recited in claim 34, wherein the weak, wide-blocksize block cipher is a mode of operation of a conventional block cipher.

36. An apparatus as recited in claim 34, wherein at least one of said operations depends on a tweak.

37. A method as recited in claim 34, wherein said masking operation uses multiplication in a finite field.

38. A method as recited in claim 34, wherein said masking operation uses a mask obtained by XORing together portions of the intermediate value.

40. A secure disk drive, the disk drive organized into a sequence of sectors, the contents of some or all of the sectors being encrypted depending on a key, a plaintext value, and the index of the sector within the sequence of sectors, at least one said sectors being encrypted by a process comprising:
enciphering plaintext using a first enciphering scheme which forms an intermediate value;
masking the bits of the intermediate value and forming a masked intermediate value;
deciphering the masked intermediate value using a second enciphering scheme which thereby forms the encrypted sector.

41. A secure disk drive as recited in claim 40, wherein at least one of said steps depends on a tweak.

42. A secure disk drive as recited in claim 40, wherein said masking step uses multiplication in a finite field.

43. A secure disk drive as recited in claim 40, wherein said masking step uses a mask obtained by XORing together portions of the intermediate value.

44. An enciphering method, comprising:
computing a first intermediate value from a plaintext;
computing a mask from the first intermediate value;
computing a second intermediate value from the first intermediate value and the mask; and
computing a ciphertext from the second intermediate value.

45. A method as recited in claim 44, further comprising:
computing said second intermediate value from said ciphertext;
computing said mask from said second intermediate value;
computing said first intermediate value from said second intermediate value and said mask; and
computing said plaintext from said first intermediate value.

46. An enciphering method, comprising:
computing a first intermediate value from a ciphertext;
computing a mask from the first intermediate value;
computing a second intermediate value from the first intermediate value and the mask; and
computing a plaintext from the second intermediate value.

47. A method as recited in claim 46, further comprising:
computing said second intermediate value from said plaintext;
computing said mask from said second intermediate value;
computing said first intermediate value from said second intermediate value and said mask; and
computing said ciphertext from said first intermediate value
